(19) United States
(12) Patent Application Publication
(10) Pub. No.: US 2012/0115382 A1
(43) Pub. Date: May 10, 2012

(54) MAGNETIC REINFORCING COMPOSITION, REINFORCING SHEET AND METHODS FOR PRODUCING THE SAME

(75) Inventor: Svetlana Contrada, Manalapan, NJ (US)

(73) Assignee: Nitto Denko Automotive, Inc., Lakewood, NJ (US)

(21) Appl. No.: 12/940,345

(22) Filed: Nov. 5, 2010

(51) Int. Cl. B32B 5/02; B32B 27/38; B05D 3/02; H01F 1/01

(52) U.S. Cl. 442/180; 252/62.54; 428/221; 442/394; 428/418; 428/414; 427/386

(57) ABSTRACT

A magnetic reinforcing composition as a material for forming a reinforcing sheet, the magnetic reinforcing composition comprising a ferromagnetic filler and an epoxy resin mixture comprising a low molecular weight epoxy resin and a high molecular weight epoxy resin; a method of making the magnetic reinforcing composition; a reinforcing sheet comprising the magnetic reinforcing composition; a method of making the reinforcing sheet; a reinforced substrate comprising the reinforcing sheet on a side of a substrate; and a method of reinforcing a substrate, including providing the reinforcing sheet on a side of the substrate. A substrate reinforced by the reinforcing sheet comprising the magnetic reinforcing composition exhibits improved properties, such as, for example, having few or no sink marks and high bending or flexural strength.

### FIELD OF THE INVENTION

The present invention relates to a magnetic reinforcing composition, a reinforcing sheet and methods for producing the same. More particularly, the present invention relates to a magnetic reinforcing composition capable of forming reinforcing sheets for the reinforcement of substrates, such as, for example, metal sheets or steel plates.

### BACKGROUND OF THE INVENTION

Reinforcing sheets are used widely for reinforcing various substrates, such as sheet metal or steel plates. In particular, reinforcing sheets are commonly used in the automotive industry for reinforcing the steel parts used in vehicle bodies. These parts typically include rigid and thin exterior plates such as those for roofs, fenders, hoods, trunks, quarter-panels and doors. For example, sheet metal to be used in the shell of a transportation vehicle, such as, e.g., an automobile, may be thin, having a thickness of, e.g., from 0.6 mm to 0.8 mm, in order to minimize vehicle weight. Such thin sheets may be susceptible to stress deformation.

Typically, to combat stress deformation, manufacturers have been known to provide a reinforcing sheet on a side of a substrate, such as sheet metal, e.g., by adhesively bonding a reinforcing sheet on the inside of the sheet metal. The reinforcing sheet and sheet metal combination may undergo a curing and foaming process to develop the reinforcing property of the reinforcing sheet. For example, U.S. Pat. No. 5,151,327 discloses an adhesive sheet comprising a thermosetting resin composition layer and a reinforcing substrate laminated or embedded therewith. Such an adhesive sheet can be used to reinforce thin rigid plates and provides the plates with good application properties after curing and foaming.

Various compositions have been developed for forming a reinforcing sheet. One example is U.S. Pat. No. 6,774,171, which discloses a composition comprising a polymeric material, an additive and a magnetic material, that provides various functions such as sealing, baffling, vibrational and acoustical dampening, and structural reinforcement. Another example is WO 2006/076310 (U.S. Publication No. 2008/0311405), incorporated by reference herein. WO 2006/076310 discloses a reinforcing sheet comprising a constraining layer and a reinforcing layer, wherein the reinforcing layer contains a foam composition containing an epoxy resin, an epoxy-modified rubber, and a hydrophobic hydrocarbon oil. The reinforcing layer and the constraining layer, which may provide stiffness to the reinforcing layer, may be adhesively bonded together, and the resulting reinforcing sheet may then be adhesively bonded to a substrate, such as, for example, sheet metal. The adhesive sheet that is bonded to the sheet metal may be thermally foamed, cross-linked and cured to form a reinforcing sheet containing a foamed reinforcing layer. There exists a need, however, for a reinforcing sheet with an improved reinforcing layer in order to provide additional improved properties to selected substrates.

During the curing and foaming process, deformation of the sheet metal can occur due to stress. Such deformation may lead to the formation of defects such as sink marks on the surface of the sheet metal and may impart an undesirable non-uniform appearance to the sheet metal, especially after paint is applied to the surface of the sheet metal. The aforementioned references and other teachings have not adequately addressed the problem of sink marks with regard to the application of reinforcing sheets on substrates such as sheet metal, nor have they shown why the property of low or no sink marks would be advantageous for reinforcing compositions.

It is known that the sink mark property is directly related to the elastic modulus of the reinforcing sheet, such that using a reinforcing sheet having a lower elastic modulus would result in less sink marks on the reinforced substrate. However, a decrease in the elastic modulus has a negative impact of reducing the reinforcing ability of the reinforcing sheet. A reinforcing material with a lower elastic modulus is generally not as desirable because it is softer and therefore the resulting reinforced substrate would not have as high of a bending or flexural strength.

Therefore, there exists a need for an improved reinforcing composition for forming reinforcing sheets that can provide substrates with a low or no sink mark property and at the same time with similar or higher levels of reinforcement than conventional compositions.

### SUMMARY OF THE INVENTION

An object of the present invention is to provide a magnetic reinforcing composition capable of forming a reinforcing sheet for the reinforcement of substrates, such as, for example, metal sheets or steel plates. It is another object of the present invention to provide a magnetic reinforcing composition for the reinforcement of substrates such that the reinforced substrates exhibit improved properties, such as, for example, having few or no sink marks and high bending or flexural strength. It is a further object of the present invention to provide a reinforced sheet comprising the magnetic reinforcing composition. It is yet another object of the present invention to provide a method of making the magnetic reinforcing composition, as well as reinforced sheets made from the magnetic reinforcing composition.

In a first aspect, the present invention is directed to a magnetic reinforcing composition as a material for forming a reinforcing sheet, the magnetic reinforcing composition comprising:

an epoxy resin mixture comprising a low molecular weight epoxy resin and a high molecular weight epoxy resin, the epoxy resin mixture present in an amount between about 5% and about 95% by weight of the magnetic reinforcing composition; and

a ferromagnetic filler, the ferromagnetic filler present in an amount between about 5% and about 95% by weight of the magnetic reinforcing composition.

Preferred aspects of the composition are as follows. The low molecular weight epoxy resin preferably has an epoxide equivalent weight of from about 70 to about 260 g/eq. The high molecular weight epoxy resin preferably has an epoxide equivalent weight of from about 400 to about 1000 g/eq. The ferromagnetic filler may be a ferrite. The magnetic reinforcing composition may further comprise a curing agent and a blowing agent.

In a second aspect, the present invention relates to a magnetic reinforcing composition as a material for forming a reinforcing sheet, made by the steps of:

providing an epoxy resin mixture comprising a low molecular weight epoxy resin and a high molecular weight epoxy resin, the epoxy resin mixture present in an amount between about 5% and about 95% by weight of the magnetic reinforcing composition; and

mixing and kneading the epoxy resin mixture with a ferromagnetic filler at a temperature ranging from about 95° C. to about 120° C. and at a shear rate of at least 90 sec⁻¹, the ferromagnetic filler present in an amount between about 5% and about 95% by weight of the magnetic reinforcing composition.

In yet another aspect, the present invention is a method of making a magnetic reinforcing composition for forming a reinforcing sheet, comprising the steps of:

providing an epoxy resin mixture comprising a low molecular weight epoxy resin and a high molecular weight epoxy resin, the epoxy mixture present in an amount between about 5% and about 95% by weight of the magnetic reinforcing composition; and

mixing and kneading the epoxy mixture with a ferromagnetic filler at a temperature ranging from about 95° C. to about 120° C. and at a shear rate of at least 90 sec⁻¹, the ferromagnetic filler present in an amount between about 5% and about 95% by weight of the magnetic reinforcing composition.

The mixing step may include the use of an extruder. In addition, the mixing step may comprise mixing the epoxy resin mixture and the ferromagnetic filler with a curing agent and a blowing agent.

Further, the present invention relates to a reinforcing sheet, the reinforcing sheet comprising a constraining layer and a reinforcing layer, wherein the reinforcing layer is made from the magnetic reinforcing composition described above.

Still further, the present invention relates to a reinforced substrate, the reinforced substrate comprising a reinforcing sheet on a side of a substrate. The reinforcing sheet comprises a constraining layer and a reinforcing layer, wherein the reinforcing layer is made from the magnetic reinforcing composition described above, in a cured state. The constraining layer may include a material selected from the group consisting of a glass fiber cloth, a resin-impregnated glass fiber cloth, a synthetic resin unwoven cloth, and a metal foil. The present invention also relates to a method of reinforcing a substrate, comprising providing the reinforcing sheet described above on a side of a substrate, and treating the reinforcing layer to a cured state. The substrate may be sheet metal.

Other objects, features, and advantages of the present invention will become apparent from the following detailed description.

### BRIEF DESCRIPTION OF THE DRAWINGS

FIG. 1 is a schematic of equipment used to measure warpage of the sample, as discussed further below.

FIG. 2a further illustrates warpage measurement techniques, showing that before applying the reinforcing sheet having the magnetic reinforcing composition on the aluminum panels and baking, there is no gap between the supporting steel plate and the aluminum panels.

FIG. 2b further illustrates warpage measurement techniques such that after applying the reinforcing sheet and baking, the gap between the aluminum panel and supporting steel plate was observed and reported as the warp value in mm.

### DETAILED DESCRIPTION OF THE INVENTION

The magnetic reinforcing composition of the present invention is a material capable of, but not limited to, forming reinforcing sheets for the reinforcement of substrates, such as, for example, metal sheets or steel plates. The invention finds particular utility in the automotive industry. The magnetic reinforcing composition includes a ferromagnetic filler and an epoxy resin mixture comprising a low molecular weight epoxy resin and a high molecular weight epoxy resin. Under preferred mixing conditions, reaction of the ferromagnetic filler and the epoxy mixture can desirably take place and form a composition useful for forming reinforcing sheets that, in turn, can provide substrates with improved properties. Preferably, the magnetic reinforcing composition can provide substrates with a low or no sink mark property and at the same time with similar or higher levels of reinforcement than conventional compositions.

A sink mark is generally understood as a depression on a surface of the substrate and is caused by shrinkage of the material during cooling or curing. Sink marks may impart an undesirable non-uniform appearance to a substrate such as sheet metal, especially after paint is applied to the surface of the sheet metal, as discussed above.

Preferred embodiments of the present invention can provide substrates with few or no sink marks while ensuring that the substrate has good bending or flexural strength. The evaluation and test methods for sink marks and physical properties of the reinforcing sheets having the magnetic reinforcing composition are provided in detail further below. Preferably, a reinforcing sheet comprising the magnetic reinforcing composition has an integrated area value under a modulus G′ curve of about 3,000×10⁹ Pa×deg. C. or below ranging from about 40° C. to about 180° C., with the modulus values obtained in the cooling process after curing the reinforcing sheet. The reinforcing sheet comprising the magnetic reinforcing composition preferably has a flexural bend strength of a minimum of about 196 N, when the reinforcing sheet is measured at a peak load after baking at 180° C. for 30 minutes using a sample size of dimensions 25 mm×150 mm that is applied to a steel panel having a thickness of 0.8 mm. In addition, as described in further detail below, the reinforcing sheet comprising the magnetic reinforcing composition preferably has a maximum warp value of about 1.0 mm after baking the reinforcing sheet at 180° C. for 30 minutes using a sample size of dimensions 25 mm×100 mm with a thickness of 1.0 mm that is applied to a steel panel with dimensions of 25 mm×150 mm with a thickness of 0.8 mm.

Suitable ferromagnetic fillers are not particularly limited and may include, e.g., ferrites, such as strontium ferrite and barium ferrite, and iron oxides. One particularly preferred type of ferromagnetic filler for use in the present invention is sold under the tradename HM410 “Starbond” strontium ferrite powder by Hoosier Magnetics, Inc. The composition may include between about 5% and about 95% by weight ferromagnetic filler. Preferably, the composition includes between 20% and 60% by weight ferromagnetic filler. The ferromagnetic filler is preferably provided as particles in powder form.

The magnetic reinforcing composition may contain blends of solid and liquid epoxy resins. Preferably, the epoxy resin mixture includes liquid epoxy resins.

Suitable epoxy resins for the epoxy mixture are not particularly limited, as long as the molecular weight range differential is maintained. Preferred compositions may contain an aromatic epoxy resin, such as a bisphenol epoxy resin (e.g., bisphenol A type epoxy resin, dimer acid-modified bisphenol A type epoxy resin, bisphenol F type epoxy resin, bisphenol S type epoxy resin, etc.). Preferred compositions may use dimer acid-modified bisphenol A type epoxy resin as the high molecular weight epoxy resin and diglycidyl ether bisphenol A epoxy resin as the low molecular weight epoxy resin.

The magnetic reinforcing composition may include between about 5% and about 95% by weight epoxy resin mixture. Preferably, the composition includes between 20% and 50% epoxy resin mixture. The composition may include between about 2% and about 15% by weight low molecular weight epoxy resin, preferably between about 2% to about 8%, and between about 5% and about 48% high molecular weight epoxy resin, preferably between about 25% and about 35%. The low molecular weight epoxy resin in the epoxy mixture preferably has an epoxide equivalent weight of from about 70 to about 260 g/eq. More preferably the low molecular weight epoxy resin has an epoxide equivalent weight of from about 75 to about 200 g/eq, and even more preferably between about 82 to about 192 g/eq. The high molecular weight epoxy resin in the epoxy resin mixture preferably has an epoxide equivalent weight of from about 400 to about 1000 g/eq. More preferably the high molecular weight epoxy resin has an epoxide equivalent weight of from about 460 to about 800 g/eq, even more preferably between about 600 to about 725 g/eq.

The full range of additional components which may be included in the composition is not particularly limited. For example, the composition may contain other components, such as epoxy-modified rubber and hydrophobic hydrocarbon oil. Preferably, the composition further comprises a curing agent, a blowing agent, and a foaming agent. As described in WO 2006/076310 (U.S. Publication No. 2008/0311405), the pertinent teachings and concrete examples of which are herein discussed below, a reinforcing sheet and a reinforcing composition may include additional components.

Suitable epoxy-modified rubbers for the composition are not particularly limited. An epoxy-modified rubber may be a rubber which has been modified with an epoxy group at an end of the molecular chain or in the molecular chain.

Suitable hydrophobic hydrocarbon oils for the composition are not particularly limited. The hydrophobic hydrocarbon oil may be a hydrophobic liquid rubber. For example, the hydrophobic hydrocarbon oil may be a polybutene.

The magnetic reinforcing composition may contain a curing agent, and especially epoxy resin curing agents. Suitable curing agents are not particularly limited. For example, the curing agent may be an isocyanate compound, an amine compound (e.g., ethylenediamine, propylenediamine, diethylenetriamine, triethylenetetramine, amine adducts thereof, metaphenylenediamine, diaminodiphenylmethane, and diaminodiphenylsulfone), an acid anhydride compound (e.g., phthalic anhydride, maleic anhydride, tetrahydrophthalic anhydride, hexahydrophthalic anhydride, methyl nadic anhydride, pyromelletic anhydride, dodecenylsuccinic anhydride, dichlorosuccinic anhydride, benzophenonetetracarboxylic anhydride, and chlorendic anhydride), an amide compound (e.g., dicyandiamide and polyamide), a hydrazide compound (e.g., dihydrazide), an imidazole compound (e.g., methyl imidazole, 2-ethyl-4-methyl imidazole, ethyl imidazole, isopropyl imidazole, 2,4-dimethylimidazole, phenylimidazole, undecylimidazole, heptadecylimidazole, and 2-phenyl-4-methylimidazole), an imidazoline compound (e.g., methylimidazoline, 2-ethyl-4-methylimidazoline, ethylimidazoline, isopropylimidazoline, 2,4-dimethylimidazoline, phenylimidazoline, undecylimidazoline, heptadecylimidazoline, and 2-phenyl-4-methyl imidazoline), a phenol compound, a urea compound, or a polysulfide compound. A particular curing agent may be used alone or in combination with other curing agents.

Preferred compositions may contain dicyandiamide as a curing agent. Such a curing agent may be especially desirable for its strong ability to promote adhesiveness.

The magnetic reinforcing composition may contain a blowing agent. Suitable blowing agents are not particularly limited and may include, e.g., an inorganic blowing agent and/or an organic blowing agent. A particular blowing agent may be used alone or in combination with other blowing agents. In addition, a blowing agent may be used together with a blowing co-agent, such as, e.g., zinc stearate, a urea compound, a salicyclic compound, and a benzoic compound.

Suitable inorganic foaming agents may include, e.g., ammonium carbonate, ammonium hydrogen carbonate, sodium hydroxide, sodium hydroammonium, sodium hydrogen carbonate, ammonium nitrite, sodium borohydride, and azides.

Suitable organic foaming agents may include, e.g., an N-nitroso compound (e.g., N,N′-dinitrosopentamethylenetetramine, N,N′-dimethyl-N,N′-dinitrosoterephthalamide, etc.), an azoic compound (e.g., azobis(isobutyronitrile), azodicarboxylic amide, barium azodicarboxylate, azodicarbonamide, etc.), an alkane fluoride (e.g., trichloromonofluoromethane-, dichloromonofluoromethane, etc.), a hydrazine compound (e.g., paratoluene sulfonyl hydrazide, diphenylsulfone-3,3′-disulfonyl hydrazide, 4,4′-oxybis(benzene sulfonyl hydrazide), allylbis(sulfonyl hydrazide), etc.), a semicarbazide compound (e.g., p-toluoylenesulfonyl semicarbazide, 4,4′-oxybis(benzene sulfonyl semicarbazide, etc.), and a triazole compound (e.g., 5-morphoryl-1,2,3,4-thiatriazole, etc.).

Preferred compositions may contain 4,4′-oxybis(benzene sulfonyl hydrazide) as a blowing agent. Such blowing agents may be especially desirable for their lack of susceptibility to external factors and foaming stability.

The magnetic reinforcing composition may contain a crosslinking accelerator. Suitable crosslinking accelerators which may be included in the foam composition are not particularly limited. For example, the crosslinking accelerator may be a zinc oxide, a dithiocarbamic acid, a thiazole, a guanidine, a sulfenamide, a thiuram, a xanthogenic acid, an aldehyde ammonia, an aldehyde amine, or a thiourea. A particular crosslinking accelerator may be used alone or in combination with other crosslinking accelerators.

Other than the ferromagnetic filler, the magnetic reinforcing composition may also contain other types of fillers. Suitable fillers may include, but are not limited to, calcium carbonate (e.g., calcium carbonate heavy, calcium carbonate light, and colloidal calcium carbonate, etc.), talc, mica, clay, mica powder, bentonite, silica, alumina, an aluminum silicate, a titanium oxide, aluminum hydroxide, acetylene black, barium sulfate, magnesium hydroxide, carbon black, glass fiber, a rheological additive, aluminum powder, or other inorganic non-magnetizable fillers.

In addition to those mentioned above, additional classes of materials from which components of the magnetic reinforcing composition may be selected include, but are not limited to, pigments (e.g., carbon black, etc.), thixotropic agents (e.g., montmorillonite, etc.), lubricants (e.g., stearic acid, etc.), antiscorching agents, stabilization agents, softening agents (e.g., process oil, extender oil, etc.), plasticizers, antiaging agents, antioxidants, ultraviolet absorbers, coloring agents, mildewproofing agents, and fire retardants.

Preferred compositions may contain carbon black and organo montmorillonite thixotropic agent.

The magnetic reinforcing composition of the present invention can be obtained by providing an epoxy resin mixture comprising a low molecular weight epoxy resin and a high molecular weight epoxy resin, and then mixing and kneading the epoxy mixture with a ferromagnetic filler. In preferred embodiments, this occurs at a temperature ranging from about 95° C. to about 120° C. and at a shear rate of at least 90 sec⁻¹. More preferably, the epoxy mixture is mixed with the ferromagnetic filler at a temperature of about 100° C. and at a shear rate of about 95 sec⁻¹. Under these preferred mixing conditions, a desired reaction of the ferromagnetic filler and the epoxy resin mixture can take place and form a composition for forming reinforcing sheets that can provide substrates with improved properties, such as low or no sink marks. Such an effect is particularly achieved through the use of the low molecular weight epoxy resin that can react with the ferromagnetic filler and provide effective stress relief.

The reinforcing sheet of the present invention includes a constraining layer and a reinforcing layer, the reinforcing layer comprising the magnetic reinforcing composition. Specific techniques for preparing the magnetic reinforcing composition and the reinforcing sheet comprising the composition are not particularly limited. For example, the composition can be prepared in the form of kneaded material by mixing and kneading the epoxy mixture with the ferromagnetic filler and any additional components mentioned above by using, for example, a banbury mixer, a planetary mixer, an open kneader, a sigma blade mixer, a mixing roll, a pressure kneader, or an extruder. The kneaded material may then be rolled, for example, to form a reinforcing layer by calendaring, extrusion or press molding at a temperature that allows the base polymer to flow but does not decompose components of the composition, such as the blowing agent. This reinforcing layer may be adhesively bonded to a constraining layer to form a reinforcing sheet. The constraining layer may be in the form of a sheet, and may be formed of any suitable material, such as a metal foil, glass cloth, carbon fiber cloth, polyester or other polymer film, etc. One side of the reinforcing layer is bonded with the constraining layer, whereas the other side is typically covered with a removable layer, such as siliconized paper, siliconized polymer film, or some other substrate that may be stripped from the surface of the reinforcing layer prior to use. Preferably, the reinforcing sheet comprising the magnetic reinforcing composition is magnetized to a magnetic flux density value of about 1 to about 30 mT.

The reinforcing sheet thus obtained may be adhesively bonded to a substrate to be reinforced, such as, for example, sheet metal. The resulting assembly may be heated at a temperature sufficient for a blowing and curing reaction to occur (e.g., 140-210° C.). Using the magnetic reinforcing composition of the present invention, the resulting reinforced substrates, such as, for example, reinforced sheet metal, may exhibit improved properties, such as having few or no sink marks and high bending or flexural strength.

End-uses for the reinforcing sheets comprising the magnetic reinforcing composition are not particularly limited. For example, the reinforcing sheets may be used to reinforce sheet metal to be used in the shell of an automobile. However, the use of such reinforcing sheets is not limited to the automotive industry. The reinforcing sheets can also be used for the reinforcement of various other metal parts.

### EXAMPLES

The following specific examples further illustrate the present invention.

A) Example and Comparative Example Formulation

The magnetic reinforcing compositions of Sample 1 and Comparative Sample 2 having the formulation shown in Table 1 (parts by weight) below were prepared by mixing and kneading the components for 5 minutes using a 3L sigma blade mixer at various temperatures ranging from about 95° C. to about 120° C. and at various shear rates of at least 90 sec⁻¹, as specified below in Table 2. The magnetic reinforcing composition was placed between the layers of 0.2 mm thick glass cloth and siliconized paper release liner and pressed using a heat press machine to a total thickness of the reinforcing layer (1.0 mm). The glass fiber cloth had previously undergone sizing treatment with a melamine resin (glass cloth weight=220 g/m²; sizing agent amount=20 g/m²). A three-layer reinforcing sheet was thus obtained.

TABLE 1

| | | | Comparative |
|---|---|---|---|
| No. | Raw Material | Sample 1 | Sample 2 |
| 1 | Bisphenol A epoxy | 3.3 | 3.3 |
| | resin (solid) | | |
| 2 | Strontium Ferrite powder | 53.4 | 53.4 |
| 3 | Cyanoguanidine | 1.81 | 1.81 |
| 4 | Organo | 2.7 | 2.7 |
| | Montmorillonite | | |
| 5 | Phenyl dimethyl urea | 0.15 | 0.15 |
| 6 | Carbon black | 0.3 | 0.3 |
| 7 | Bisphenol A epoxy resin | 32.3 | 32.3 |
| | (high molecular weight) | | |
| 8 | Bisphenol A epoxy resin | 2.4 | — |
| | (low molecular weight) | | |
| 9 | Blowing agent | 1.5 | 1.5 |
| 10 | Blowing co-agent | 1 | 1 |

In Table 1 above, the magnetic reinforcing compositions of Sample 1 and Comparative Sample 2 have the same formulation, except that the composition of Comparative Sample 2 does not contain low molecular weight Bisphenol A epoxy resin. Each of the indicated raw materials listed in Table 1 above is commercially available from the following manufacturers:
No. 1: Bisphenol A epoxy resin (solid)
   Product name: DER661
   Supplier: Dow Chemical
   EEW=500-550 g/eq
No. 2 Starbond Strontium Ferrite Powder
   Product name: HM 410
   Supplier: Hoosier Magnetics, Inc.
No. 3 Cyanoguanidine
   Product name: AMICURE CG325
   Supplier: Air Products and Chemicals
No. 4 Organo montmorillonite
   Product name: Claytone HT
   Supplier: D.H. Litter
No. 5 Phenyl dimethyl urea
   Product name: OMICURE U405
   Supplier: CVC Thermoset Specialties
No. 6 Carbon Black
   Product name: Arosperse 11
   Supplier: Degussa
No. 7 Bisphenol A epoxy resin (semi-solid)
   Product name: HyPox DA323
   Supplier: CVC Thermoset Specialties
   EEW=600-725 g/eq
No. 8 Bisphenol A epoxy resin (liquid)
   Product name: Epalloy 7190
   Supplier: CVC Thermoset Specialties
   EEW=182-192 g/eq
No. 9 Blowing agent (azo-di-carbonamide)
   Product name: Celogen AZ130
   Supplier: Lion Copolymer
No. 10 Blowing co-agent (urea)
   Product name: BYK-OT
   Supplier: Chemrep Co.

Preferred embodiments of the present invention use HyPox DA323 Bisphenol A epoxy resin as the high molecular weight epoxy resin for the composition and EPALLOY 7190 Bisphenol A epoxy resin as the low molecular weight epoxy resin. Preferably, the magnetic reinforcing composition includes between about 1% and about 10% by weight DER661 Bisphenol A epoxy resin (solid), between about 20% and about 60% Starbond HM410 Strontium Ferrite powder, between about 1% and about 5% AMICURE CG325 Cyanoguanidine, between about 1% and about 10% Claytone HT Organo montmorillonite, between about 0.1% and about 2% OMICURE U405 Phenyl dimethyl urea, between about 1% and about 10% Arosperse 11 Carbon Black, between about and about 25% and about 35% HyPox DA323 Bisphenol A epoxy resin, between about 2% and about 8% EPALLOY 7190 Bisphenol A epoxy resin, and between about 1% and about 5% Celogen AZ130 Blowing agent and BYK-OT Blowing co-agent.

Magnetic reinforcing compositions as in Sample 1 were prepared by mixing and kneading the components for 5 minutes using a 3L sigma blade mixer at various temperatures and shear rates. Table 2 confirms that under particularly preferred mixing conditions, reaction of the ferromagnetic filler and the epoxy resin mixture can take place and form a composition for forming reinforcing sheets that can provide substrates with improved properties, such as having few or no sink marks. The existence of sink marks was determined by analyzing the modulus curve of the compositions using a rheometer. Particularly, Table 2 shows that it is highly preferable to mix the ferromagnetic filler and epoxy mixture at a temperature of about 100° C. and at a shear rate of about 95 sec⁻¹. A differential scanning calorimeter (DSC) was used to confirm these results. DSC curves were measured for Sample 1 made under different mixing conditions. A single peak of an endothermic reaction appeared in DSC curves measuring the Sample from Test No. 1, which exhibited the property of low or no sink marks (“panel deformations” in the table). Double peaks of an endothermic reaction appeared in DSC curves measuring the Samples from Tests No. 2 and 3, which exhibited sink marks. Preferably, the DSC curves measuring magnetic reinforcing compositions of the present invention would result in curves having a single peak. However, DSC curves measuring magnetic reinforcing compositions of the present invention may also exhibit double peaks.

TABLE 2

| | Mixing | Mixing | |
|---|---|---|---|
| Test No. using | Temp. | Speed/Shear | Panel |
| Sample 1 | (deg. C.) | (sec⁻¹) | Deformations |
| Test No. 1 | 100 | 95 | no |
| Test No. 2 | 90 | 80 | yes |
| Test No. 3 | 100 | 80 | yes |
| Test No. 4 | 90 | 95 | yes |

B) Evaluation and Test Methods

The properties of the reinforcing sheets having the magnetic reinforcing composition were evaluated and tested. Table 3 illustrates the results from the evaluation of Sample 1 under different mixing conditions. Specifically, Sample 1 made under standard mixing conditions (e.g., at a temperature of about 90° C. and at a shear rate of about 80 sec⁻¹) was tested, and Sample 1 made under the preferred mixing conditions (e.g., at a temperature of about 100° C. and at a shear rate of about 95 sec⁻¹) was tested.

First, the elastic modulus after cure (G′, kPa) was determined using a rheometer from Alpha Technology, APA-2000P (Advanced Polymer Analyzer with Pressure option), equipped with parallel-plate cavity. Measurement was conducted at a frequency of 1.67 Hz and 0.05 angle. A sufficient amount of composite material to fully fill the cavity was placed and torque was measured as the material was cured at 180° C. for 30 minutes and then cooled down from 180° C. to 40° C. Measured torque values were recalculated by software to generate the elastic modulus (G′). After cure was completed, G′ in cooling mode from 180° C. to 40° C. was plotted against temperature. The area under the G′ curve in cooling mode was shown by previous studies to be correlated with composite material ability to accumulate stress and therefore cause metal deformation in warp test.

Using the test method described above, the elastic modulus after cure was determined for the samples in Table 1 above. It was found that Sample 1 from Table 1 has a low elastic modulus, while Comparative Sample 2 has a high elastic modulus. This indicated that the reinforcing sheet for Sample 1 is soft and more flexible to relieve the stress during curing, while the reinforcing sheet for Comparative Sample 2 is hard and does not relieve the stress during the cooling process after cure. Specifically, it was determined that a reinforcing sheet comprising the magnetic reinforcing composition preferably has an integrated area value under a modulus G′ curve of about 3,000×10⁹ Pa×deg. C. or below ranging from about 40° C. to about 180° C., with the modulus values obtained in the cooling process after curing the reinforcing sheet.

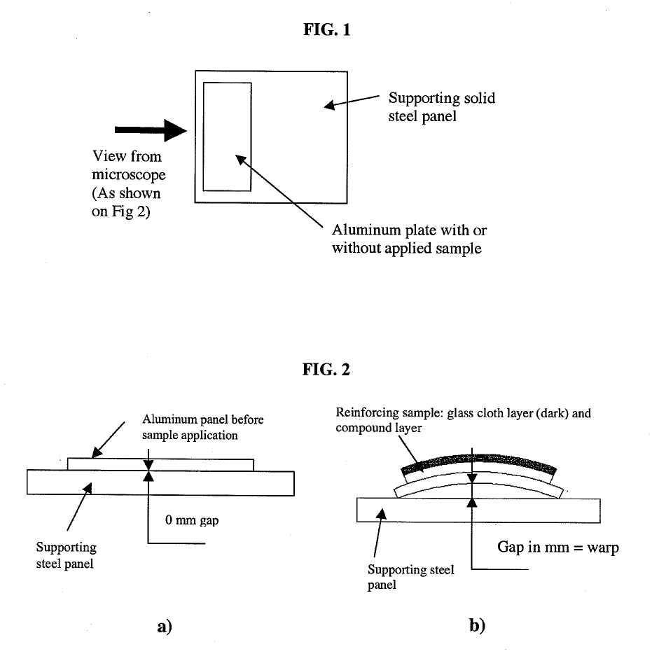

Second, the warpage was determined by using a Keyence digital microscope VXH. A reinforcing sample with size dimensions of 1.0 mm thickness×25 mm width×100 mm length was applied to flat aluminum panels having size dimensions of 0.8 mm thickness×25 mm width×150 mm length, baked at 180° C. for 30 minutes, and then cooled down for 24 hours at 25° C. To ensure flatness (+/−5 micrometers) and minimum residual stress, the aluminum panels were prepared by grinding solid aluminum to the required thickness. As illustrated in FIG. 1, the microscope was set up with the lens facing the side of the sample to check that there was no gap between the aluminum panels and the flat substrate serving as support for the sample in warp test. The origin of the gap is from aluminum plate deformation under stress accumulated during the cooling down process after cure. As illustrated in FIG. 2a, before applying the reinforcing sheet having the magnetic reinforcing composition on the aluminum panels and baking, there is no gap between the supporting steel plate and the aluminum panels. As illustrated in FIG. 2b, after applying the reinforcing sheet and baking, the gap between the aluminum panel and supporting steel plate was observed and reported as the warp value in mm. It was determined that the reinforcing sheet comprising the magnetic reinforcing composition preferably has a maximum warp value of about 1.0 mm after baking the reinforcing sheet at 180° C. for 30 minutes using a sample size of dimensions 25 mm×100 mm with a thickness of 1.0 mm that is applied to a steel panel with dimensions of 25 mm×150 mm with a thickness of 0.8 mm.

Third, the flexural strength was tested per ASTM D790M, with 100 mm constant support span, 6.4 mm radius loading nose, 5 mm/min constant crosshead rate, compression, and the load applied to substrate surface. Samples (with size dimensions of 25 mm×100 mm) were cut in the machine direction and applied to 25 mm×150 mm×0.8 mm steel panels. A 2.2 kg roller was used to roll down the sample that was applied to the steel panels. The sample was conditioned at 23+/−2 deg. C. and 50+/−5% R.H. for 1 hour prior to oven cure. After conditioning, samples were baked at 180° C. for 30 minutes to allow the foaming and curing process to occur. After baking, the samples were cooled down to room temperature, held at room temperature for a minimum of 2 hours, and tested for flexural strength. It was determined that the reinforcing sheet comprising the magnetic reinforcing composition preferably has a flexural bend strength of a minimum of about 196 N, when the reinforcing sheet is measured at a peak load after baking at 180° C. for 30 minutes using a sample size of dimensions 25 mm×150 mm that is applied to a steel panel having a thickness of 0.8 mm.

TABLE 3

| | Sample 1 | Sample 1 |
|---|---|---|
| | (made using | (made using |
| | preferred* | standard** mixing |
| Property | mixing conditions) | conditions) |
| Expansion ratio, times | 2.17 | 2.42 |
| Integrated area under | 444 | 1411 |
| G′ curve, GPa × deg. C. | | |
| Warpage, mm | 0.10 | 0.55 |
| Bend strength, kg/25 mm | 25.3 | 26.0 |

*preferred mixing conditions = temperature of about 100° C. and a shear rate of about 95 sec⁻¹
**standard mixing conditions = temperature of about 90° C. and a shear rate of about 80 sec⁻¹

The properties of a competitive product (Reinforcing Magnetic Patch by L&L Products) were evaluated and tested using the methods described above. Test results showed that the competitive product has an integrated area value under a modulus G′ curve of about 18,600×10⁹ Pa×deg. C., a flexural bend strength of about 19.4 kg/25 mm, and a warp value of about 3.2 mm. These tests illustrate that, in comparison to the competitor product, the magnetic reinforcing composition of the present invention is dramatically superior for reinforcing substrates such as, for example, sheet metal.

Comparative Samples 3-6 having the formulations shown in Table 4 (parts by weight) below were also prepared and tested using the methods described above. Other than as specified in Table 4, the Comparative Samples have essentially the same formulation and components as Sample 1 in Table 1. In comparison to the Comparative Samples, Sample 1 has a much lower warpage value (thus less sink marks) and a comparatively high flexural strength despite having a low elastic modulus. The higher warpage value of Comparative Sample 4, which does not contain low molecular weight Bisphenol A epoxy resin, demonstrates the importance of mixing in low molecular weight epoxy resin with the ferromagnetic filler in order to obtain a reinforced substrate with low warpage. The test results in Table 4 also illustrate that the weight ratio of high molecular weight epoxy resin to low molecular weight epoxy resin in the compositions affects the resulting elastic modulus and the warpage values.

TABLE 4

| | | | Comp. | Comp. | Comp. | Comp. |
|---|---|---|---|---|---|---|
| | Sample | Sample | Sample | Sample | Sample | Sample |
| | 1 | 1 | 3 | 4 | 5 | 6 |
| Mixing | 100° C. | 90° C. | 90° C. | 90° C. | 90° C. | 90° C. |
| Conditions | 95 sec⁻¹ | 80 sec⁻¹ | 80 sec⁻¹ | 80 sec⁻¹ | 80 sec⁻¹ | 80 sec⁻¹ |
| Strontium | 53.4 | 53.4 | — | 53.4 | 53.4 | 53.4 |
| Ferrite | | | | | | |
| powder | | | | | | |
| Bisphenol A | 32.3 | 32.3 | 32.3 | 35 | 20 | 13 |
| epoxy resin | | | | | | |
| (high molecular | | | | | | |
| weight) | | | | | | |
| Bisphenol A | 2.4 | 2.4 | 2.4 | — | 15 | 22 |
| epoxy resin | | | | | | |
| (low molecular | | | | | | |
| weight) | | | | | | |
| Talc | — | — | 50 | — | — | — |
| Integrated Area | 444 | 1411 | 1342 | 860 | 5614 | 17736 |
| under G′ Curve | | | | | | |
| (GPa × deg. | | | | | | |
| C.) | | | | | | |
| Warpage (mm) | 0.10 | 0.55 | 0.60 | 0.52 | 1.32 | 2.7 |
| Flexural | 25.3 | 26.0 | 22.5 | 26.6 | 24.7 | 28.2 |
| Strength | | | | | | |
| (kg/25 mm) | | | | | | |

While the present invention has been described in detail and with reference to specific embodiments, it will be apparent to one skilled in the art that various changes and modifications can be made therein without departing from the spirit and scope thereof.

What is claimed is:

1. A magnetic reinforcing composition as a material for forming a reinforcing sheet, the magnetic reinforcing composition comprising:
an epoxy resin mixture comprising a low molecular weight epoxy resin and a high molecular weight epoxy resin, the epoxy resin mixture present in an amount between about 5% and about 95% by weight of the magnetic reinforcing composition; and
a ferromagnetic filler, the ferromagnetic filler present in an amount between about 5% and about 95% by weight of the magnetic reinforcing composition.

2. The magnetic reinforcing composition as claimed in claim 1, further comprising a curing agent and a blowing agent.

3. The magnetic reinforcing composition as claimed in claim 1, wherein the low molecular weight epoxy resin has an epoxide equivalent weight of from about 70 to about 260 g/eq.

4. The magnetic reinforcing composition as claimed in claim 1, wherein the high molecular weight epoxy resin has an epoxide equivalent weight of from about 400 to about 1000 g/eq.

5. The magnetic reinforcing composition as claimed in claim 1, wherein the ferromagnetic filler is a ferrite.

6. A magnetic reinforcing composition as a material for forming a reinforcing sheet, made by the steps of:
providing an epoxy resin mixture comprising a low molecular weight epoxy resin and a high molecular weight epoxy resin, the epoxy mixture present in an amount between about 5% and about 95% by weight of the magnetic reinforcing composition; and
mixing and kneading the epoxy mixture with a ferromagnetic filler at a temperature ranging from about 95° C. to about 120° C. and at a shear rate of at least 90 sec⁻¹, the ferromagnetic filler present in an amount between about 5% and about 95% by weight of the magnetic reinforcing composition.

7. The magnetic reinforcing composition as claimed in claim 6, wherein the mixing step includes use of an extruder.

8. The magnetic reinforcing composition as claimed in claim 6, wherein the mixing step comprises mixing the epoxy resin mixture and the ferromagnetic filler with a curing agent and a blowing agent.

9. The magnetic reinforcing composition as claimed in claim 6, wherein the low molecular weight epoxy resin has an epoxide equivalent weight of from about 70 to about 260 g/eq.

10. The magnetic reinforcing composition as claimed in claim 6, wherein the high molecular weight epoxy resin has an epoxide equivalent weight of from about 400 to about 1000 g/eq.

11. The magnetic reinforcing composition as claimed in claim 6, wherein the ferromagnetic filler is a ferrite.

12. A method of making a magnetic reinforcing composition for forming a reinforcing sheet, comprising the steps of:
providing an epoxy resin mixture comprising a low molecular weight epoxy resin and a high molecular weight epoxy resin, the epoxy resin mixture present in an amount between about 5% and about 95% by weight of the magnetic reinforcing composition; and
mixing and kneading the epoxy resin mixture with a ferromagnetic filler at a temperature ranging from about 95° C. to about 120° C. and at a shear rate of at least 90 sec⁻¹, the ferromagnetic filler present in an amount between about 5% and about 95% by weight of the magnetic reinforcing composition.

13. The method of making a magnetic reinforcing composition as claimed in claim 12, wherein the mixing step includes use of an extruder.

14. The method of making a magnetic reinforcing composition as claimed in claim 12, wherein the mixing step comprises mixing the epoxy resin mixture and the ferromagnetic filler with a curing agent and a blowing agent.

15. The method of making a magnetic reinforcing composition as claimed in claim 12, wherein the low molecular weight epoxy resin has an epoxide equivalent weight of from about 70 to about 260 g/eq.

16. The method of making a magnetic reinforcing composition as claimed in claim 12, wherein the high molecular weight epoxy resin has an epoxide equivalent weight of from about 400 to about 1000 g/eq.

17. The method of making a magnetic reinforcing composition as claimed in claim 12, wherein the ferromagnetic filler is a ferrite.

18. A reinforcing sheet, comprising a constraining layer and a reinforcing layer, wherein the reinforcing layer comprises a magnetic reinforcing composition comprising:
an epoxy resin mixture comprising a low molecular weight epoxy resin and a high molecular weight epoxy resin, the epoxy resin mixture present in an amount between about 5% and about 95% by weight of the magnetic reinforcing composition; and
a ferromagnetic filler, the ferromagnetic filler present in an amount between about 5% and about 95% by weight of the magnetic reinforcing composition.

19. The reinforcing sheet as claimed in claim 18, wherein the magnetic reinforcing composition further comprises a curing agent and a blowing agent.

20. The reinforcing sheet as claimed in claim 18, wherein the low molecular weight epoxy resin has an epoxide equivalent weight of from about 70 to about 260 g/eq.

21. The reinforcing sheet as claimed in claim 18, wherein the high molecular weight epoxy resin has an epoxide equivalent weight of from about 400 to about 1000 g/eq.

22. The reinforcing sheet as claimed in claim 18, wherein the ferromagnetic filler is a ferrite.

23. The reinforcing sheet as claimed in claim 18, wherein the constraining layer comprises a material selected from the group consisting of a glass fiber cloth, a resin-impregnated glass fiber cloth, a synthetic resin unwoven cloth, and a metal foil.

24. The reinforcing sheet as claimed in claim 18, further comprising a removable layer on the opposite side of the reinforcing layer from the constraining layer.

25. A reinforced substrate, comprising a reinforcing sheet on a side of a substrate, wherein the reinforcing sheet comprises a constraining layer and a reinforcing layer, wherein the reinforcing layer comprises a cured magnetic reinforcing composition comprising:
an epoxy resin mixture comprising a low molecular weight epoxy resin and a high molecular weight epoxy resin, the epoxy resin mixture present in an amount between about 5% and about 95% by weight of the magnetic reinforcing composition; and
a ferromagnetic filler, the ferromagnetic filler present in an amount between about 5% and about 95% by weight of the magnetic reinforcing composition.

26. The reinforced substrate as claimed in claim 25, wherein the substrate comprises sheet metal.

27. The reinforced substrate as claimed in claim 25, wherein the low molecular weight epoxy resin has an epoxide equivalent weight of from about 70 to about 260 g/eq.

28. The reinforced substrate as claimed in claim 25, wherein the high molecular weight epoxy resin has an epoxide equivalent weight of from about 400 to about 1000 g/eq.

29. The reinforced substrate as claimed in claim 25, wherein the ferromagnetic filler is a ferrite.

30. The reinforced substrate as claimed in claim 25, wherein the constraining layer comprises a material selected from the group consisting of a glass fiber cloth, a resin-impregnated glass fiber cloth, a synthetic resin unwoven cloth, and a metal foil.

31. A method of reinforcing a substrate, comprising
providing a reinforcing sheet on a side of a substrate, wherein the reinforcing sheet comprises a constraining layer and a reinforcing layer, wherein the reinforcing layer comprises a magnetic reinforcing composition comprising an epoxy resin mixture comprising a low molecular weight epoxy resin and a high molecular weight epoxy resin, the epoxy resin mixture present in an amount between about 5% and about 95% by weight of the magnetic reinforcing composition, and a ferromagnetic filler, the ferromagnetic filler present in an amount between about 5% and about 95% by weight of the magnetic reinforcing composition, and
treating the reinforcing sheet so as to cure the reinforcing layer.

32. The method of reinforcing a substrate as claimed in claim 31, wherein the substrate comprises sheet metal.

33. The method of reinforcing a substrate as claimed in claim 31, wherein the magnetic reinforcing composition to be cured further comprises a curing agent and a blowing agent.

34. The method of reinforcing a substrate as claimed in claim 31, wherein the low molecular weight epoxy resin has an epoxide equivalent weight of from about 70 to about 260 g/eq.

35. The method of reinforcing a substrate as claimed in claim 31, wherein the high molecular weight epoxy resin has an epoxide equivalent weight of from about 400 to about 1000 g/eq.

36. The method of reinforcing a substrate as claimed in claim 31, wherein the ferromagnetic filler is a ferrite.

37. The method of reinforcing a substrate as claimed in claim 31, wherein the constraining layer comprises a material selected from the group consisting of a glass fiber cloth, a resin-impregnated glass fiber cloth, a synthetic resin unwoven cloth, and a metal foil.
